(19) United States
(12) Patent Application Publication
(10) Pub. No.: US 2025/0317957 A1
(43) Pub. Date: Oct. 9, 2025

(54) Dependent Scheduling of Redundantly Connecting Wireless Devices

(71) Applicant: Telefonaktiebolaget LM Ericsson (publ), Stockholm (SE)

(72) Inventors: Majid Gerami, Lund (SE); Junaid Ansari, Aachen (DE)

(21) Appl. No.: 18/865,606

(22) PCT Filed: May 17, 2022
(86) PCT No.: PCT/EP2022/063295

§ 371 Date: Nov. 13, 2024

(51) Int. Cl. H04W 72/543; H04L 1/00

(52) U.S. Cl. CPC H04W 72/543; H04L 1/0003; H04L 1/0009

(57) ABSTRACT

A node (100) of the wireless communication network determines whether multiple wireless devices (10) redundantly connect a same remote device (21) to the wireless communication network. In response to determining that the wireless devices (10) redundantly connect the same remote device (21) to the wireless communication network, the node (100) schedules one or more first wireless transmissions of at least one of the wireless devices (10) depending on scheduling of one or more second wireless transmission of at least one other of the wireless devices (10).

### TECHNICAL FIELD

The present invention relates to methods for controlling wireless transmissions and to corresponding devices, systems, and computer programs.

### BACKGROUND

In wireless communication networks, e.g., based on the 4G (4th Generation) LTE (Long Term Evolution) or 5G (5th Generation) NR technology as specified by 3GPP (3rd Generation Partnership Project), wireless transmissions to or from a UE (user equipment) are typically scheduled from the network side. For example, in the LTE technology an access node denoted as “eNB” (Evolved Node B″) is responsible for scheduling wireless transmissions. In the NR technology, an access node denoted as “gNB” (Next Generation Node B) is responsible for scheduling wireless transmissions.

For example in the NR technology, a scheduler in the gNB is responsible for resource allocation for UEs in connected mode both in uplink (UL), for wireless transmissions from the UE to the network, and in downlink (DL), i.e., for wireless transmissions from the network to the UE. The scheduler may receive input related to a required quality of service (QOS) for each UE or each service provided to a UE. Such QoS requirements may for example be indicated from the core network (CN). The scheduler cooperates with a link adaptation (LA) algorithm, e.g., to select proper transport block formats for UL and DL wireless transmissions. The LA algorithm may also decide on radio resource assignment for the UE based on the estimated SINR (Signal to Interference and Noise Ratio), success or failure of the UE's previous wireless transmissions, e.g., as typically indicated by ACK/NACK feedback, the UE's power headroom, and the available bandwidth.

Communication among machines and production lines within a factory is typically based on industrial LAN (Local Area Network) networking. Different networking technologies may be utilized, including for example Bridged Ethernet. Larger subnetworks of the factory may be interconnected via IP (Internet Protocol) routing. Ethernet LAN may also be complemented with fieldbus technologies or real-time industrial Ethernet variants, which can provide deterministic performance, e.g., on latency. TSN (Time Sensitive Networking) standards aim at a standardized industrial Ethernet technology, which supplements Ethernet LAN with time-sensitive features. TSN is expected to replace over time legacy and mutually incompatible real-time Ethernet variants, and thereby the former “local real-time network segments” will be merged into the general Ethernet network. By supporting time sensitive communication, TSN integration can also be enabled in a 5G network based on the NR technology, e.g., with the aim of supporting Industrial Internet of Things (IIoT) solutions.

Features of the 5G NR technology that enable TSN integration include URLLC (ultra-reliable and low latency communication), direct support for TSN, general Time Sensitive Communications (TSC), including Ethernet-level TSN and other IP-level communications to provide service to e.g., Video, Imaging and Audio for Professional Applications (VIAPA).

In order to support highly reliable URLLC services, a UE may set up two redundant PDU (Packet Data Unit) Sessions over the 5G network, such that the 5GS (5G System) sets up user plane paths of the two redundant PDU sessions to be disjoint. The user's subscription indicates if user is allowed to have redundant PDU Sessions. The specific way of using the redundant user plane paths may rely on higher layer protocols, such as the IEEE 802.1 TSN FRER (Frame Replication and Elimination for Reliability) standard. Such higher layer protocol can for example manage the replication and elimination of redundant packets or frames.

When using redundant user plane paths based on the TSN FRER framework or a similar higher layer protocol, there will be multiple UEs that are connected to a device to provide more reliable communication for critical data. However, from the perspective of the wireless communication network, e.g., from the perspective of the node responsible for scheduling the wireless transmissions to or from the UEs, the UEs may appear as independent devices. This may result in inefficient scheduling and suboptimal performance.

Accordingly, there is a need for techniques which allow for efficiently handling situations where multiple UEs may redundantly provide wireless connectivity to the same remote device.

### SUMMARY

According to an embodiment, a method of controlling communication in a wireless communication network is provided. According to the method, a node of the wireless communication network determines whether multiple wireless devices redundantly connect a same remote device to the wireless communication network. In response to determining that the wireless devices redundantly connect the same remote device to the wireless communication network, the node schedules one or more first wireless transmissions of at least one of the wireless devices depending on scheduling of one or more second wireless transmission of at least one other of the wireless devices.

According to a further embodiment, a node for a wireless communication network is provided. The node is configured to determine whether multiple wireless devices redundantly connect a same remote device to the wireless communication network. Further, the node is configured to, in response to determining that the wireless devices redundantly connect the same remote device to the wireless communication network, schedule one or more first wireless transmissions of at least one of the wireless devices depending on scheduling of one or more second wireless transmission of at least one other of the wireless devices.

According to a further embodiment, a node for a wireless communication network is provided. The node comprises at least one processor and a memory. The memory contains instructions executable by said at least one processor, whereby the node is operative to determine whether multiple wireless devices redundantly connect a same remote device to the wireless communication network. Further, the memory contains instructions executable by said at least one processor, whereby the node is operative to, in response to determining that the wireless devices redundantly connect the same remote device to the wireless communication network, schedule one or more first wireless transmissions of at least one of the wireless devices depending on scheduling of one or more second wireless transmission of at least one other of the wireless devices.

According to a further embodiment of the invention, a computer program or computer program product is provided, e.g., in the form of a non-transitory storage medium, which comprises program code to be executed by at least one processor of a node for a wireless communication network. Execution of the program code causes the node to determine whether multiple wireless devices redundantly connect a same remote device to the wireless communication network. Further, execution of the program code causes the node to, in response to determining that the wireless devices redundantly connect the same remote device to the wireless communication network, schedule one or more first wireless transmissions of at least one of the wireless devices depending on scheduling of one or more second wireless transmission of at least one other of the wireless devices.

Details of such embodiments and further embodiments will be apparent from the following detailed description of embodiments.

### BRIEF DESCRIPTION OF THE DRAWINGS

FIG. 1 schematically illustrates a wireless communication network according to an embodiment.

FIG. 2 schematically illustrates an example of a scenario involving a redundant wireless connection according to an embodiment.

FIG. 3A schematically illustrates a scheduling procedure according to an embodiment.

FIG. 3B schematically further illustrates processes in a scheduling procedure according to an embodiment.

FIG. 4A schematically a scheduling request according to an embodiment.

FIG. 4B schematically a buffer status report according to an embodiment.

FIG. 4C schematically an RRC message according to an embodiment.

FIG. 5A schematically illustrates an example of a UL scheduling process according to an embodiment.

FIG. 5B schematically illustrates an example of a DL scheduling process according to an embodiment.

FIG. 6 shows a flowchart for schematically illustrating a method according to an embodiment.

FIG. 7 schematically illustrates structures of a network node according to an embodiment.

### DETAILED DESCRIPTION

In the following, concepts in accordance with exemplary embodiments of the invention will be explained in more detail and with reference to the accompanying drawings. The illustrated embodiments relate to controlling of wireless communication between a wireless communication network and one or more wireless devices (WDs). The wireless communication network may be based on the 5G NR technology specified by 3GPP. However, other technologies could be used as well, e.g., the 4G LTE technology specified by 3GPP or a future 6G (6th Generation) technology. The WD may correspond to various types of UEs or other types of WDs.

In the illustrated concepts, multiple WDs, in the following denoted as UEs, may redundantly provide wireless connectivity for the same remote device. Specifically, each of the UEs may provide a wireless connection with respect to the remote device, and these multiple wireless connections may be utilized in a redundant manner to convey data from the remote device or to the remote device. The redundant wireless connections may also be referred to as replicated data paths. The UEs may for example operate based on the TSN FRER framework or a similar higher layer protocol. The remote device can for example be an IIoT device, e.g., a machine, robot, or other device within a factory, e.g., in a production line. The data conveyed via the multiple wireless connections may for example have the purpose of controlling and/or supervising the remote device. A node of the wireless communication network is responsible for scheduling wireless transmissions on the multiple wireless links.

This node may in particular be an access node, e.g., an eNB of the LTE technology or a gNB of the NR technology. In response to determining that the multiple UEs provide redundant wireless connections to the same remote device, the node may schedule the wireless transmissions on the multiple wireless connections in a dependent manner. In particular, the node may schedule one or more first wireless transmissions of at least one of the UEs depending on scheduling of one or more second wireless transmission of at least one other of the UEs. The dependent scheduling may for example involve selecting radio resources, e.g., in terms of PRBs (Physical Resource Blocks) and/or transmission parameters, e.g., MCS (Modulation and Coding Scheme) and/or BLER (Block Error Rate) target of the first wireless transmission(s) depending on radio resources, e.g., selected PRBs, and/or transmission parameters, e.g., selected MCS and/or BLER target, of the second wireless transmission(s). In some cases, the dependent scheduling may also involve that the node decides to refrain from scheduling a wireless transmission on one of the wireless connections, e.g., if another wireless connection is expected to be sufficient to convey the data with a required QoS level, e.g., a sufficiently high reliability and/or sufficiently low latency.

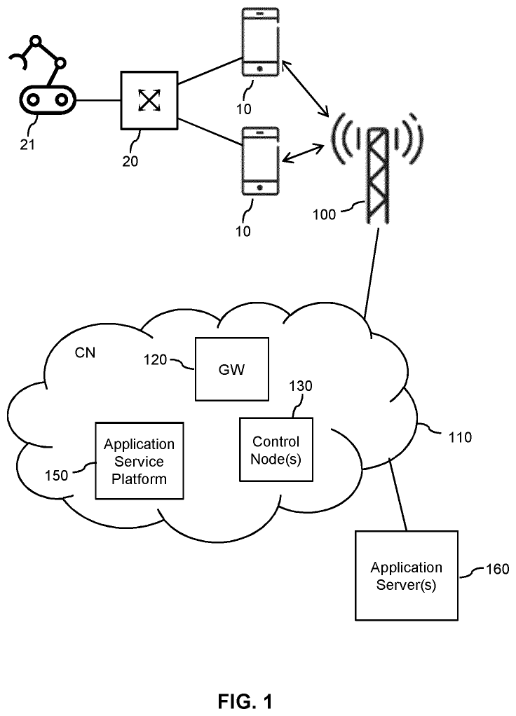

FIG. 1 illustrates exemplary structures of the wireless communication network. In particular, FIG. 1 shows UEs 10 which are served by an access nodes 100 of the wireless communication network. Here, it is noted that the wireless communication network may actually include a plurality of access nodes 100 that may serve a number of cells within the coverage area of the wireless communication network. The access nodes 100 may be regarded as being part of an RAN of the wireless communication network. Further, FIG. 1 schematically illustrates a CN (Core Network) 110 of the wireless communication network. In FIG. 1, the CN 110 is illustrated as including a GW (gateway) 120 and one or more control node(s) 140. The GW 120 may be responsible for handling user plane data traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The GW may for example correspond to a UPF (User Plane Function) of the 5G Core (EGC) or to an SGW (Serving Gateway) or PGW (Packet Data Gateway) of the 4G EPC (Evolved Packet Core). The control node(s) 140 may be used for controlling the user data traffic, e.g., by providing control data to the access node 100, the GW 120, and/or to the UE 10.

As illustrated by solid double-headed arrows, the access node 100 may send DL wireless transmissions to at least some of the UEs 10, and some of the UEs 10 may send UL wireless transmissions to the access node 100. As further illustrated, the UEs 10 connect through a bridge device 20 to a remote device 21, e.g., an IIoT device, like a machine, robot, or other device within a factory, e.g., in a production line. The remote device 21 can for example be a TSN station, and the bridge device 20 can be a Device Side TSN translator (DS-TT).

The DL transmissions and UL transmissions may be used to provide various kinds of services to the remote device 21, e.g., a TSN service, a VIAPA service, or some other kind of URLLC service. Such services may be hosted in the CN 110, e.g., by a corresponding network node. By way of example, FIG. 1 illustrates an application service platform 150 provided in the CN 110. Further, such services may be hosted externally, e.g., by an AF (application function) connected to the CN 110. By way of example, FIG. 1 illustrates one or more application servers 160 connected to the CN 110. The application server(s) 160 could for example connect through the Internet or some other wide area communication network to the CN 110. The application service platform 150 may be based on a server or a cloud computing system and be hosted by one or more host computers. Similarly, the application server(s) 160 may be based on a server or a cloud computing system and be hosted by one or more host computers. The application server(s) 160 may include or be associated with one or more AFs that enable interaction with the CN 110 to provide one or more services through the UEs 10 to the remote device 21, corresponding to one or more applications. These services or applications may generate the user data traffic conveyed by the DL transmissions and/or the UL transmissions between the access node 100 and the respective UE 10. Accordingly, the application server(s) 160 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the user plane data traffic between the UEs 10 and the access node 100.

As mentioned above, the UEs 10 may provide redundant wireless connections to the remote device 21, and the access node 100 may consider this situation when scheduling the UL and DL wireless transmissions on the redundant wireless connections by scheduling the wireless transmissions in a dependent manner. The UEs 10 providing the redundant connections may also be referred to as UE group. The redundant usage of the wireless connections may in particular involve replicated transmission of the same transport block (TB) over each of the multiple wireless connections, thereby improving reliability and/or reducing latency.

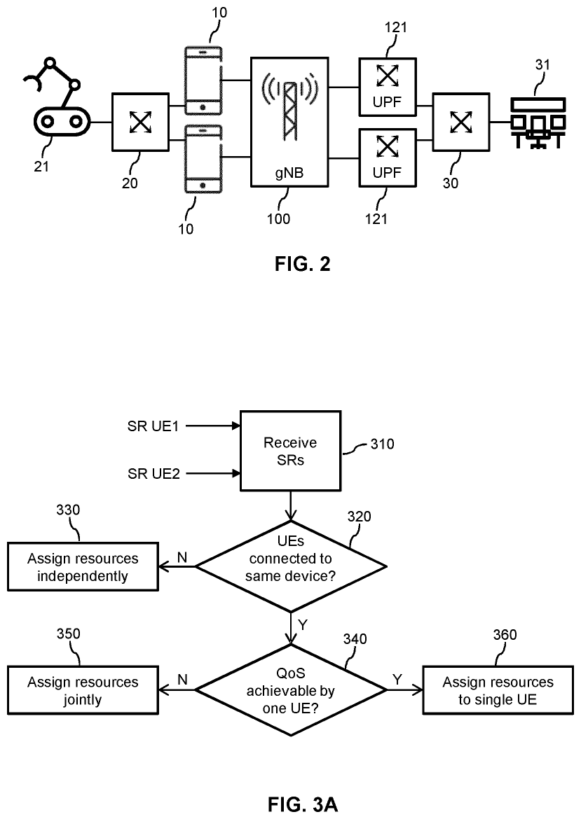

In the following, the dependent scheduling will be further explained by referring to an exemplary scenario as further illustrated in FIG. 2. The example of FIG. 2 assumes that two TSN end stations 21, 31 are connected through the 5GS. The TSN end station 21 may for example correspond to the remote device 21 of FIG. 2. The DS-TT 20 connects the TSN end station 21 to two UEs 10, which provide the redundant wireless connections to the access node 100, which in the example of FIG. 2 is assumed to be a gNB. The TSN end station 31 in turn connects through a Network Side TSN Translator (NS-TT) 30 and two user-plane gateways 121, which in the example of FIG. 2 are assumed to be UPFs, to the access node 100. Accordingly, two redundant user plane data paths are formed between the DS-TT 20 and the NS-TT 30. The access node 100 is however responsible for scheduling the wireless transmissions on the wireless parts of both user plane data paths.

In the illustrated concepts, the access node 100 may first determine that the multiple UEs 10 provide redundant wireless connections to the same remote device 21. This may be involve that the UEs 10 inform the access node 100 that their user plane data traffic relates to the same remote device 21, e.g., by providing a corresponding indication in a scheduling request (SR), in a buffer status report (BSR), or in an RRC (Radio Resource Control) message. Alternatively or in addition, the access node 100 could assign the UEs 10 to the UE group which is responsible for providing the redundant wireless connections to the remote device 21.

The replication of data for transmission on the redundant wireless connections may be controlled in a dynamic manner. For example, the DS-TT 20 may check the QoS requirements of UL data to be transmitted via the UEs 10 and the access node 100 to the TSN end station 31 and decide to replicate critical UL data on the multiple user plane paths. Uncritical UL data may however be transmitted without replication, i.e., by only one of the UEs 10. Similarly, the DS-TT 20 may check the QoS requirements of DL data to be transmitted via the access node 100 and the UEs 10 to the TSN end station 21 and decide to replicate critical DL data on the multiple user plane paths. Uncritical data may however be transmitted without replication, i.e., to only one of the UEs 10. In each case, the access node 100 may perform scheduling for the wireless transmission(s) between the access node 100 and at least one of the UEs 10. For the critical UL or DL data, a pessimistic BLER target and a robust MCS may be a preferred selection.

When performing the dependent scheduling of a wireless transmission of a TB on one of the wireless connections and a redundant wireless transmission of the same TB on the other wireless connection, the access node 100 may consider the following criteria: The access node 100 may select the PRBs for the wireless transmissions with the aim of ensuring a high degree of frequency diversity. Accordingly, the wireless transmissions of the different UEs 10 may be distributed or spaced apart in the frequency domain. In this way, a frequency diversity gain can be achieved for the redundant wireless transmissions. In addition or as an alternative, the dependent scheduling may consider carrier aggregation on the wireless connections. This may involve assigning the different UEs 10 to different component carriers. In this way, frequency diversity gains can be achieved and flexibility of scheduling can be improved. In addition or as an alternative, the dependent scheduling may consider frequency layer or cell selection. This may involve selecting different cells or frequency layers for the different UEs 10, again allowing to increase frequency diversity.

As regards the MSC selection, the dependent scheduling performed by the access node 100 may operate to select the MCS with the aim of achieving high resource utilization efficiency, while meeting the required reliability. For example, even though the same TB is transmitted on the multiple wireless connections, the access node 100 may select different MSCs for the redundant wireless transmissions of the different UEs 10. The selection of the different MCSs can be based on a lookup table and/or on analytics performed by the access node.

Depending upon the QoS requirements of the data to be transmitted, e.g., depending on whether the data corresponds to critical traffic or to background traffic, different degrees of redundancy on the multiple wireless connections can be selected. This may in turn affect the BLER targets, MCS selection, PRB selection, component carrier selection or frequency layer selection for wireless connection. For stricter QoS requirements, lower BLER targets and more robust MCSs may be selected, and vice versa.

The dependent scheduling may also involve that the access node 100 decides which wireless connection is to be utilized when uncritical data (e.g., background traffic) is to be transmitted, and which MCSs is to be utilized then. For example, the access node 100 may decide to transmit the data on only one of the wireless connections, using an MCS with high performance and an optimistic BLER target. For critical data, the access node 100 may decide to transmit the data redundantly on the multiple wireless connections and to use a robust MCS and pessimistic BLER target on each of the multiple connections.

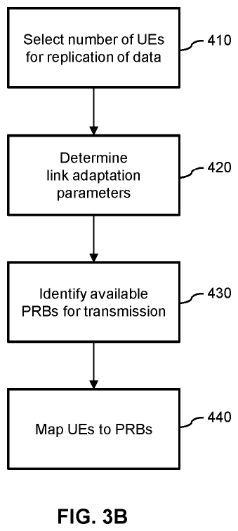

FIG. 3A schematically illustrates an example of processes for assigning resources to UEs, which can be applied in the illustrated concepts. The processes assume that two UEs, denoted as UE1 and UE2 may provide redundant wireless connections to the same remote device. These UEs may for example correspond to the UEs 10 of FIG. 1 or 2, and the remote device may correspond to the remote device 21 of FIG. 1 or TSN end device 21 of FIG. 2. The resource assignment processes may be part of the dependent scheduling performed by the access node 100.

At block 310, the access node 100 receives an SR from UE1 and an SR from UE2. At block 320, the access node 100 determines whether the UEs are connected to the same remote device. If this is not the case, the access node 100 proceeds to assigning resources independently for UE1 and UE2, as indicated by branch “N” and block 330. If the access node determines that the UEs are connected to the same remote device, the access node proceeds to block 340, as indicated by branch “Y”.

At block 340, the access node 100 determines whether QoS requirements for the requested data transmissions of UE1 and UE2 can be achieved by only one of UE1 and UE2, i.e., by a non-redundant wireless transmission on only one of the wireless connections provided by UE1 and UE2. If this is not the case, the access node 100 proceeds to jointly assigning resources for two redundant wireless transmissions on the wireless connections provided by UE1 and UE2, as indicated by branch “N” and block 350. The joint assignment of resources may for example be based on the above-mentioned principles of increasing frequency diversity. If the QoS requirements can be achieved by a non-redundant wireless transmission on only one of the wireless connections provided by UE1 and UE2, the access node 100 proceeds to block 360 and assigns resources to only a single UE, as indicated by branch “Y”.

FIG. 3B schematically illustrates an example of processes assigning a PRBs to the different UEs. The processes of FIG. 3B may be part of the dependent scheduling performed by the access node 100, e.g., in the joint assignment of resources of block 350 of FIG. 3A.

At block 410, the access node The scheduler determines which UEs 10 of the UE group need to be involved for the data communication in the group based on the QoS requirements. For example, when considering the above examples with two UEs 10 in the UE group, the access node 100 could determine that both UEs need to participate in redundant wireless transmissions in order to mee the QoS requirements.

A block 420, the access node 420 may determine link adaptation parameters for each of the wireless connections. For each participating UE, the link adaptation parameters may include the MCS and a number of PRBs required for the wireless transmission.

At block 430, the access node 100 assesses the radio resource availability situation. In particular, the access node 100 identifies PRBs that are available for transmission. At block 440, the access node 100 then maps the participating UEs to the available PRBs. The mapping is performed in such a way that the participating UEs 10 are separated on different PRBs, so that there is a high degree of frequency diversity. The separation of the PRBs to which the participating UEs are mapped can be controlled on the basis of a configurable threshold. The threshold can be flexibly configured, e.g., based on the system bandwidth, the number of resources available for transmission, the utilized frequency spectrum, or the like. It is noted that in practice the mapping of block 440 may be based on determining a starting PRB for each of the participating UEs 10. Beginning from the starting PRB, the required number of PRBs can then be subsequently mapped to the respective UE 10. For instance, if 3 PRBs are required for a given UE 10 of the UE group and the starting PRB is determined to be PRB #231, PRB #231, PRB #232, and PRB #233 would be assigned to the UE 10.

In some scenarios, the dependent scheduling may also consider initial transmission and re-transmission of the data. For example, when assuming that N UEs 10 provide redundant wireless connections to the same remote device, the subset of participating UEs 10, the link adaptation parameters, and/or the selected PRBs for the initial transmission of a TB can be different from those for re-transmission of the TB. The access node 100 may decide based on QoS requirements which UEs shall participate in the initial transmission and which link adaptation parameters and PRBs shall be used. For the re-transmission, the access node 100 may then newly decide based on the QoS requirements which UEs 10 shall participate in the and which link adaptation parameters and PRBs shall be used. By way of example, in the initial transmission UE1 and UE2 may transmit a TB by MCSx, while in the re-transmission only UE1 re-transmits the TB with MCSy, where x, and y are numbers indicating different rows in an MCS selection table.

In some scenarios, the group of the UEs 10 participating in the redundant wireless transmissions to or from a certain remote device may be statically defined or dynamically selected. For example, when assuming that N UEs 10 provide redundant wireless connections to the same remote device, the access node 100 may select based om the QoS requirements K out of these N UEs 10 to participate in redundant wireless transmissions (with K≤N). The selection may be static and be applied to all redundant wireless transmissions which are subject to the same QoS requirements. Alternatively, the selection may be dynamic and for example vary depending on movement of the UEs 10 and/or depending on variations of channel conditions experienced by the UEs 10. In the case of the dynamic selection, the selection of the UEs 10 can be made by the access node, and the selection then be indicated to the UEs. Further, the selection could at least in part be decided by the UEs 10, with the access node 100 then being informed by the UEs 10 about the selection.

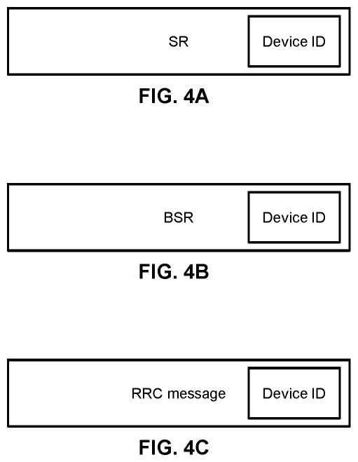

Various mechanisms may be used to inform the access node 100 that one or more UEs 10 are connected to the same remote device. For example, a device identifier (device ID) of the remote device may be included in signaling from the UEs 10 to the access node. If multiple UEs 10 signal the same device ID, the access node 100 can conclude that these UEs 10 redundantly connect to the same remote device. For example, such device ID can be included in a SR from the UE, as schematically illustrated in FIG. 4A, or in a BSR, as schematically illustrated in FIG. 4B. In a similar manner, the device ID could be included in UCI (Uplink Control Information). By means of SR, BSR, or UCI, the UEs can dynamically indicate the device ID to the access node. Further, the device ID could be included in RRC signaling from the UEs, as illustrated in FIG. 4C. For example, when a UE is changing from RRC Idle mode to RRC Connected mode, the UE 10 may include the device ID into the corresponding RRC signaling.

If the assignment of the UEs 10 to the UE group is performed by the access node 100, the access node may use various mechanisms to inform the UEs 10 about the assignment to the UE group. For example, the access node could use DCI (Downlink Control Information) to inform the UEs 10 about the assignment, by including the device ID of the remote device into the DCI. By means of DCI, the access node 100 can dynamically indicate the assignment to the UE group. Further, the access node 100 could use RRC signaling inform the UEs 10 about the assignment, by including the device ID of the remote device into the RRC signaling from the access node 100. In response to being assigned to the UE group, the UEs 10 of the group may also reduce their signaling to the access node 100, e.g., by sending a common SR, a common BSR, common UCI, or a common CSI report instead of individual reports from each UE. In some scenarios, the access node 100 could also perform the dependent scheduling without informing the UEs 10 about their assignment to the UE group.

In some scenarios, the dependent scheduling may also utilize a UL CG (UL configured grant) or DL SPS (DL Semi-Persistent Scheduling) to inform the UEs 10 about the scheduling decisions. This may be beneficial if the data traffic from or to the remote device is periodic. The UL CG may be indicated by RRC configuration, and the assignment of the UE 10 to the UE group associated with a certain remote device may be indicated by including the device ID into the ConfiguredGrantConfig information element as defined in 3GPP TS 38.331 V17.0.0 (2022-03). Similarly, the DL SPS may be indicated by RRC configuration, and the assignment of the UE 10 to the UE group associated with a certain remote device may be indicated by including the device ID into the SPSConfig information element as defined in 3GPP TS 38.331 V17.0.0.

In some scenarios, a capability of the UE 10 to provide multiple redundant connections to the same remote device may be indicated in capability signaling between the UE 10 and the access node 100.

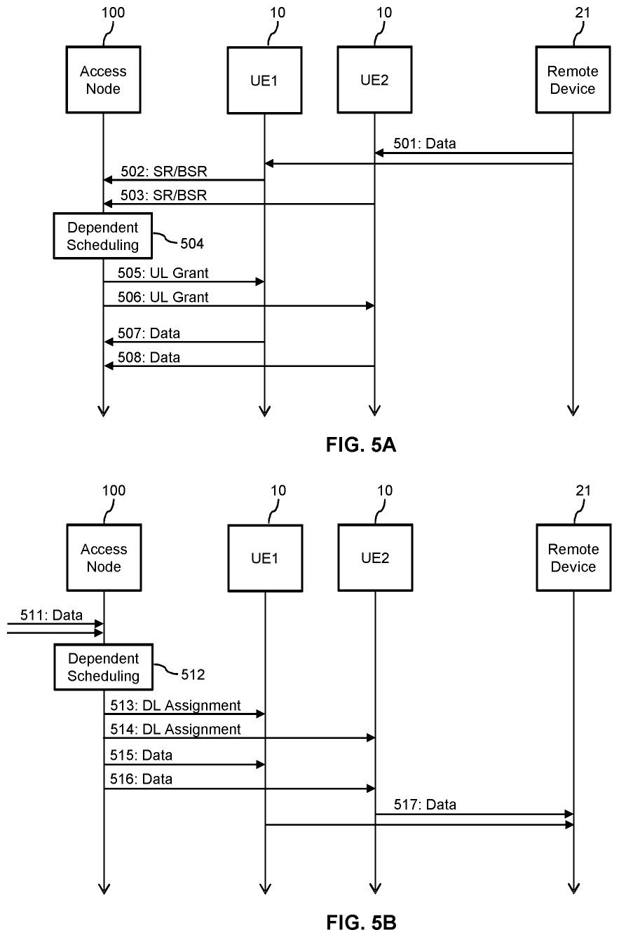

FIG. 5A schematically illustrates an example of a UL scheduling process in accordance with the illustrated concepts. The process of FIG. 5A involves the access node 100, two UEs 10, and a remote device 21, which is redundantly connected by the UEs 10 to the wireless communication network. The access node 100, the UEs 10, and the remote device 21 may correspond to the access node 100, UEs 10, and remote device 21 of the above examples. It is noted that a bridge device like in the examples of FIGS. 1 and 2 could also be used in the example of FIG. 5A.

In the example of FIG. 5A, the remote device 21 provides data 501 to the UEs 10. In response to receiving the data 501, the UEs 10 request scheduling of UL transmissions. This may be accomplished by sending an SR or a BSR, as illustrated by messages 502 and 503.

In response to receiving the SRs or BSRs, the access node 100 proceeds by scheduling the requested UL transmissions, as illustrated by block 504. In the illustrated example, it is assumed that the access node 100 is aware that the UEs 10 provide redundant wireless connections to the remote device 21. The access node 100 thus performs the scheduling in the above-described dependent manner, e.g., by assigning PRBs with the aim of providing frequency diversity of the two UEs 10.

Based on the dependent scheduling, the access node 100 then sends UL grants 505, 506 to the UEs 10. The UL grants 505, 506 indicate the results of the dependent scheduling to the UEs 10, e.g., assigned PRBs and selected MCSs. Based on the UL grants, the UEs 10 then send redundant UL transmissions 507, 508 with the same data to the access node 100.

FIG. 5B schematically illustrates an example of a DL scheduling process in accordance with the illustrated concepts. The process of FIG. 5A involves the access node 100, two UEs 10, and a remote device 21, which is redundantly connected by the UEs 10 to the wireless communication network. The access node 100, the UEs 10, and the remote device 21 may correspond to the access node 100, UEs 10, and remote device 21 of the above examples. It is noted that a bridge device like in the examples of FIGS. 1 and 2 could also be used in the example of FIG. 5B.

In the example of FIG. 5B, the access node receives data 511 to be sent to the UEs 10. In response to receiving the data 511, the access node 100 performs scheduling of DL transmissions to the UEs 10, as illustrated by block 512. In the illustrated example, it is assumed that the access node 100 is aware that the UEs 10 provide redundant wireless connections to the remote device 21. The access node 100 thus performs the scheduling in the above-described dependent manner, e.g., by assigning PRBs with the aim of providing frequency diversity of the two UEs 10.

Based on the dependent scheduling, the access node 100 then sends DL assignments 513, 514 to the UEs 10. The DL assignments 513, 514 indicate the results of the dependent scheduling to the UEs 10, e.g., assigned PRBs and selected MCSs. In accordance with the results of the scheduling, the access node 100 then sends redundant DL transmissions 515, 516 with the same data to the UEs 10. The UEs 10 forward the data to the remote device 21, as indicated by 517.

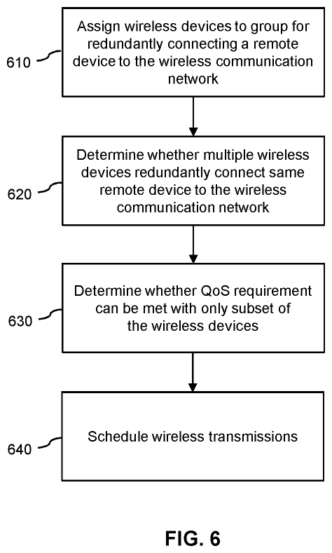

FIG. 6 shows a flowchart for illustrating a method, which may be utilized for implementing the illustrated concepts. The method of FIG. 6 may be used for implementing the illustrated concepts in a node of a wireless communication network. For example, the node may correspond to an access node, such as one of the above-mentioned access node 100.

If a processor-based implementation of the node is used, at least some of the steps of the method of FIG. 6 may be performed and/or controlled by one or more processors of the node. Such node may also include a memory storing program code for implementing at least some of the below described functionalities or steps of the method of FIG. 6.

At step 610, the node may assign wireless devices to a group for redundantly connecting a remote device to the wireless communication network. The wireless devices may correspond to UEs, such as the above-mentioned UEs 10. The remote device may be an IIoT device, e.g., a machine, robot, or other device in an industrial environment. In some scenarios, the remote device may be a TSN end station. The node may indicate the assignment of the wireless devices to the wireless devices, e.g., by DCI or RRC signaling.

At step 620, the node may determine whether multiple wireless devices redundantly connect a same remote device to the wireless communication network. This determination may for example be based on the assignment of step 610. In other scenarios, the group of wireless devices redundantly connecting the remote device to the wireless communication network could be pre-configured or be determined by the wireless devices.

At step 630, the node may determine whether a QoS requirement of data traffic of the remote device can be met by wireless transmissions of only a subset of the wireless devices, e.g., as explained for the example processes of FIG. 3A.

At step 640, the node schedules wireless transmissions of the wireless devices. In particular, in response to determining at step 620 that the wireless devices redundantly connect the same remote device to the wireless communication network, the node schedules one or more first wireless transmissions of at least one of the wireless devices depending on scheduling of one or more second wireless transmission of at least one other of the wireless devices. The scheduling is thus performed in a dependent manner, considering the possibility of a redundant wireless transmission of another wireless device. The one or more first wireless transmissions may convey data which is at least in part redundant with respect to data conveyed by the one or more second wireless transmissions. The first wireless transmissions and the second wireless transmissions may include UL wireless transmissions and/or DL wireless transmissions.

The node may perform the scheduling of step 640 in response to a message from each of the wireless devices. The messages may include at least one SR and/or at least one BSR and/or at least one RRC message. In some scenarios, the node may determine based on such messages that the wireless devices redundantly connects the same remote device to the wireless communication network: For example, if the messages each include an identifier of the same remote device, the node may determine that the wireless devices redundantly connect the same remote device to the wireless communication network.

If at step 630 the node determined that the QoS requirement can be met by the subset of wireless devices, the node may limit scheduling of wireless transmissions associated with the remote device to the subset of the wireless devices.

The scheduling of step 640 may involve assigning wireless resources for the one or more first wireless transmissions depending on wireless resources assigned for the one or more second wireless transmissions. The wireless resources for the one or more first wireless transmissions may be assigned in such a way that a frequency domain separation from the wireless resources assigned for the one or more second wireless transmissions equal to or greater than a threshold. The wireless resources for the one or more first wireless transmissions may for example include Physical Resource Blocks, PRBs, that are distinct from PRBs assigned for the one or more second wireless transmissions. Alternatively or in addition, the wireless resources for the one or more first wireless transmissions may include one or more carriers that are distinct from one or more carriers assigned for the one or more second wireless transmissions. For example, such carriers could be component carriers of a carrier aggregation configuration of the respective wireless device. Alternatively or in addition, the wireless resources for the one or more first wireless transmissions may include a frequency layer that is distinct from a frequency layer assigned for the one or more second wireless transmissions.

The scheduling of step 640 may also involve selecting an MCS for the one or more first wireless transmissions to be different from an MCS for the one or more second wireless transmissions.

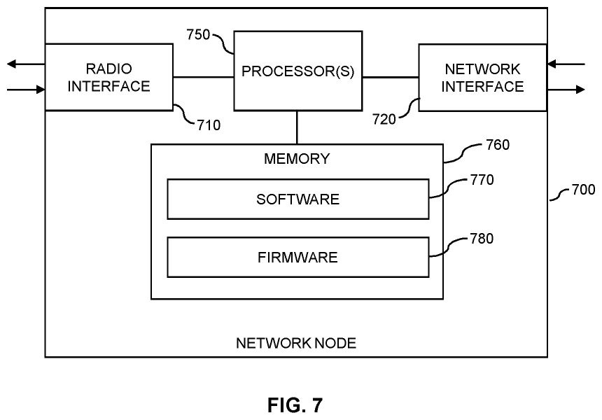

FIG. 7 illustrates a processor-based implementation of a node 700 for a wireless communication network, which may be used for implementing the above-described concepts. For example, the structures as illustrated in FIG. 7 may be used for implementing the concepts in the access node 100. The node 700 may for example implement an eNB of the LTE technology or a gNB of the NR technology.

As illustrated, the node 700 may include one or more radio interfaces 710. The radio interface(s) 710 may for example be based on the NR technology or the LTE technology.

The radio interface(s) 710 may be used for connecting to WDs, such as any of the above-mentioned UEs 10. Further, the node 700 may include one or more network interfaces 720. The network interface(s) 720 may for example be used for communication with one or more other nodes of the wireless communication network, e.g., access nodes or CN nodes.

Further, the node 700 may include one or more processors 750 coupled to the interface(s) 710, 720 and a memory 760 coupled to the processor(s) 750. By way of example, the interface(s) 710, 720, the processor(s) 750, and the memory 760 could be coupled by one or more internal bus systems of the node 700. The memory 760 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 760 may include software 770 and/or firmware 780. The memory 760 may include suitably configured program code to be executed by the processor(s) 750 so as to implement or configure the above-described functionalities for controlling wireless communication based on dependent scheduling, such as explained in connection with FIG. 6.

It is to be understood that the structures as illustrated in FIG. 7 are merely schematic and that the node 700 may actually include further components which, for the sake of clarity, have not been illustrated, e.g., further interfaces or further processors. Also, it is to be understood that the memory 760 may include further program code for implementing known functionalities of a gNB in the NR technology or an eNB in the LTE technology. According to some embodiments, also a computer program may be provided for implementing functionalities of the node 700, e.g., in the form of a physical medium storing the program code and/or other data to be stored in the memory 760 or by making the program code available for download or by streaming.

As can be seen, the concepts as described above may be used for efficiently controlling wireless communication in scenarios where multiple UEs may redundantly connect the same remote device to the wireless communication network. Specifically, efficiency of scheduling the wireless transmissions may be enhanced by taking into account that multiple wireless connection may are used in a redundant manner.

It is to be understood that the examples and embodiments as explained above are merely illustrative and susceptible to various modifications. For example, the illustrated concepts may be applied in connection with various kinds of wireless communication technologies. Further, the concepts may be applied with respect to various numbers of redundant connections. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-22. (canceled)

23. A method of controlling wireless communication, the method comprising:
a node of a wireless communication network determining whether multiple wireless devices redundantly connect a same remote device to the wireless communication network; and
in response to determining that the wireless devices redundantly connect the same remote device to the wireless communication network, the node scheduling one or more first wireless transmissions of at least one of the wireless devices depending on scheduling of one or more second wireless transmissions of at least one other of the wireless devices.

24. The method of claim 23, wherein the node performs said scheduling in response to a message from each of the wireless devices.

25. The method of claim 24, wherein the node determines that the wireless devices redundantly connect the same remote device to the wireless communication network if the messages each comprise an identifier of the remote device.

26. The method of claim 24, wherein the messages from the wireless devices comprise at least one scheduling request.

27. The method of claim 24, wherein the messages from the wireless devices comprise at least one buffer status report.

28. The method of claim 24, wherein the messages from the wireless devices comprise at least one Radio Resource Control (RRC) message.

29. The method of claim 23, wherein the node assigns the wireless devices to a group for redundantly connecting the remote device to the wireless communication network.

30. The method of claim 23, wherein said scheduling comprises assigning wireless resources for the one or more first wireless transmissions depending on wireless resources assigned for the one or more second wireless transmissions.

31. The method of claim 30, wherein the wireless resources for the one or more first wireless transmissions are assigned in such a way that a frequency domain separation from the wireless resources assigned for the one or more second wireless transmissions equal to or greater than a threshold.

32. The method of claim 30, wherein the wireless resources for the one or more first wireless transmissions comprise Physical Resource Blocks (PRBs) that are distinct from PRBs assigned for the one or more second wireless transmissions.

33. The method of claim 30, wherein the wireless resources for the one or more first wireless transmissions comprise one or more carriers that are distinct from one or more carriers assigned for the one or more second wireless transmissions.

34. The method of claim 30, wherein the wireless resources for the one or more first wireless transmissions comprise a frequency layer that is distinct from a frequency layer assigned for the one or more second wireless transmissions.

35. The method of claim 23, wherein said scheduling comprises selecting a modulation and coding scheme (MCS) for the one or more first wireless transmissions to be different from an MCS for the one or more second wireless transmissions.

36. The method of claim 23, further comprising:
the node determining whether a Quality of Service (QOS) requirement of data traffic of the remote device can be met by wireless transmissions of only a subset of the wireless devices; and
in response to determining that the QoS requirement can be met by only the subset, the node limiting scheduling of wireless transmissions associated with the remote device to the subset of the wireless devices.

37. The method of claim 23, wherein the one or more first wireless transmissions convey data which is at least in part redundant with respect to data conveyed by the one or more second wireless transmissions.

38. The method of claim 23, wherein the remote device is a Time Sensitive Networking (TSN) device.

39. A node for a wireless communication network, the node comprising communication interface circuitry and processing circuitry operatively coupled to the communication interface circuitry, the processing circuitry being configured to:
determine whether multiple wireless devices redundantly connect a same remote device to the wireless communication network; and
in response to determining that the wireless devices redundantly connect the same remote device to the wireless communication network, schedule one or more first wireless transmissions of at least one of the wireless devices depending on scheduling of one or more second wireless transmission of at least one other of the wireless devices.

40. The node of claim 39, wherein the node is configured to:
determine whether a Quality of Service (QOS) requirement of data traffic of the remote device can be met by wireless transmissions of only a subset of the wireless devices; and
in response to determining that the QoS requirement can be met by only the subset, schedule wireless transmissions associated with the remote device to the subset of the wireless devices.

41. The node of claim 39, wherein the processing circuitry comprises:
at least one processor, and
a memory containing program code executable by the at least one processor,
whereby execution of the program code by the at least one processor causes the node to carry out said determining and scheduling.

42. A non-transitory computer readable medium comprising, stored thereupon, a computer program or computer program product comprising program code to be executed by at least one processor of a node of a wireless communication network, whereby execution of the program code causes the node to:
determine whether multiple wireless devices redundantly connect a same remote device to the wireless communication network; and
in response to determining that the wireless devices redundantly connect the same remote device to the wireless communication network, schedule one or more first wireless transmissions of at least one of the wireless devices depending on scheduling of one or more second wireless transmission of at least one other of the wireless devices.
